(19) United States
(12) Patent Application Publication
(10) Pub. No.: US 2015/0088878 A1
(43) Pub. Date: Mar. 26, 2015

(54) Discovering New Media Items for a User

(71) Applicant: GOOGLE INC.

(72) Inventors: Brandon Bilinski, San Francisco, CA (US); Owen Daniel Otto, Berkeley, CA (US)

(21) Appl. No.: 14/033,839

(22) Filed: Sep. 23, 2013

(51) Int. Cl. G06F 17/30

(52) U.S. Cl. CPC G06F 17/30058
USPC 707/736

(57) ABSTRACT

A method for identifying a media item is provided. A method includes identifying a list of previously activated media items based on a plurality of sources of media activation history for a user. Each previously activated media item may have a plurality of attributes. Next, a discovery media item may be identified based on the list of previously activated media items and the discovery media item may not be included in the list of previously activated media items. Additionally, an indication of the discovery media item may be presented to the user.

### BACKGROUND

Discovering new media content, such as music, movies, books, and the like, can be a difficult and time consuming process. The intentional discovery process often begins with exploring media content sites, reading reviews of media items, receiving recommendations from friends, and keeping track of those media reviews/recommendations. Then, a user typically seeks out and accesses each of those new media items, one at a time, in order to evaluate whether or not the user enjoys the new media item. Existing media service providers may help with media discovery by presenting similar media items to a seed media item, but often times these media service providers present media items that a user already owns or has previously accessed.

### BRIEF SUMMARY

According to an embodiment of the disclosed subject matter, a method includes identifying a list of previously activated media items based on a plurality of sources of media activation history for a user. Each previously activated media item may have a plurality of attributes. Next, a discovery media item may be identified based on the list of previously activated media items and the discovery media item may not be included in the list of previously activated media items.

An implementation of the disclosed subject matter provides a system including a processor configured to identify a list of previously activated media items based on a plurality of sources of media activation history for a user. Each previously activated media item may have a plurality of attributes. Next, a discovery media item may be identified based on the list of previously activated media items and the discovery media item may not be included in the list of previously activated media items.

Implementations of the disclosed subject matter may provide a user with new media items that a user does not own and/or has never previously accessed. The disclosed subject matter provides methods for identifying a discovery media item based on a user's past media activation history such that the discovery media item is new to the user. This may improve a user's ability to discover and access new media content that the user is likely to enjoy and may result in increased user satisfaction. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process according to an implementation of the disclosed subject matter.

FIG. 2 shows an example information flow according to an implementation of the disclosed subject matter.

FIG. 3 shows a computer according to an embodiment of the disclosed subject matter.

FIG. 4 shows a network configuration according to an embodiment of the disclosed subject matter.

### DETAILED DESCRIPTION

Existing media service providers generally do not aim to present to a user only those media items that the user does not own or has never accessed before, specifically for the purpose of discovering new media items. Many media service providers offer a media activation history feature which keeps track of activation count for every media item in a user's media library; however, these service providers do not keep track of media items which the user hasn't activated and/or which the user doesn't own.

The present disclosure provides a media discovery service to a user. In particular, the presently disclosed feature generates a list of discovery media items. For example, a list of discovery media items may include songs that the user is likely to enjoy based on a user's music preferences, but the list of discovery media items may include only songs that the user has never heard and/or accessed before based on the user's music listen and/or activation histories. By identifying a comprehensive list of media items that have been previously activated by a user, the list of discovery media items provides a user with media items that are new to the user and which the user is likely to enjoy.

A media item may be any media item that may be activated by a user. For example, a media item may be a song, a video, a movie, a show, a book, a magazine, a newspaper, an e-book, an album, and the like. Activating a media item may be any action associated with a media item such as playing, displaying, presenting, listening, reviewing, rating, machine speaking, previewing, purchasing, owning, viewing, providing social media input associated with a media item, and the like. In general, a discovery media item is a media item that has never been activated by a user before. For example, a user may provide a review of a book A to a website. Although book A may not be present in the user's media library, the user's purchase history, or the like, the user's review of book A on the website may be sufficient to determine that the user has previously activated book A. Some indications that a user has activated a media item may be explicit, such as where a media provider has previously sold, provided a preview of, or played the media item to the user, where the user has explicitly indicated that he owns the media item, or the like. More generally, an explicit indication may be any indication that includes direct evidence that the user has activated the media item before. Other indications may be inferred, such as where the user provides a comment or review of a media item, a rating of a collection that includes the media item, or the like. Implementations disclosed herein may use explicit and/or inferred indications to determine that a user has previously activated a media item.

As discussed herein, a media item, including a discovery media item, may or may not be licensed by the user. A licensed media item may be owned, available through a subscription service, available on a trial basis, available for preview, and the like. A media item that is not licensed by the user may be presented to a user by way of a suggestion or recommendation for the user to license, e.g., purchase, the media item. In some instances, a media item may be licensed by a user, e.g., available to the user through a subscription service, but never previously activated. In this case, a recommendation to activate the media item may be provided to the user.

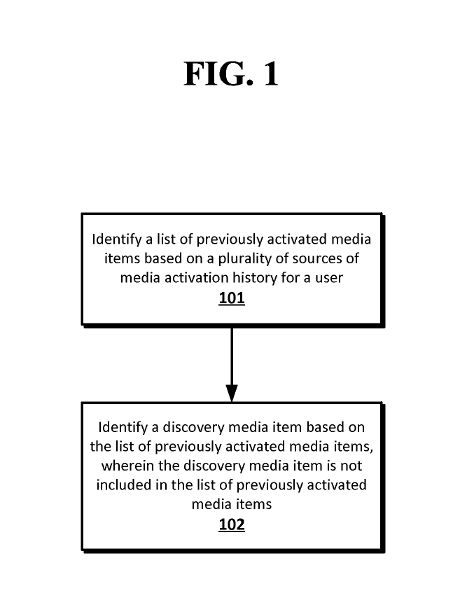

An implementation of the disclosed subject matter provides systems and methods for identifying a discovery media item. FIG. 1 shows an example process according to an implementation of the disclosed subject matter. A method may include identifying a list of previously activated media items, at 101, and the list of previously activated media items may be based on a plurality of sources of media activation history for a user. Each of the previously activated media items may have a plurality of attributes. Attributes include characteristics such as artist, album, genre, mood, tempo, release date, producer, actor, author, and any other properties relating to an activated media item. At 102, a discovery media item may be identified based on the list of previously activated media items, and the discovery media item may not be included in the list of previously activated media items. Additionally, an indication of the discovery media item may be presented to a user. Generally, any discovery media item that is identified as not being in a list of previously activated media items may be presented or suggested to the user as a discovery media item. Alternatively or in addition, various techniques may be used to select particular discovery media items to present or suggest to a user, as described in further detail herein.

As shown at 101, the list of previously activated media items may be based on a plurality of sources of media activation history for a user. As discussed herein, a previously activated media item may be a song, a video, a movie, a show, a book, a magazine, a newspaper, an e-book, an album, and the like. A source of media activation history for a user may be any source of media activation history that provides information regarding a user's previous media activation. Examples of sources of media activation history for a user may be a user's media library, a user's media viewing history, a user's media listen history from a media service provider, a user's media purchase history, a user's media preview history, a user's social media input associated with a media item, a user's review/rating history associated with a media item, and any other similar data indicating a user's media activation history. As an example, a user may provide social media input indicating that he likes the song Paradise by Coldplay. As a result, this information may be used to determine that the user has previously activated the song Paradise by Coldplay and the song may be included in the list of previously activated media items. Accordingly, the song Paradise would not be a discovery media item since the song is included in the list of previously activated media items, and presumably, the song would not be new to the user since the user has previously activated the song.

In general, a list of previously activated media items may include every previously activated media item identified from every available source of media activation history. In some cases, some sources may be excluded as unreliable and only those sources that provide a explicit indication as to a previously activated media item may be relied upon. In addition, varying combinations of sources of media activation history may be used to identify previously activated media items. In some instances, particular sources of media activation history may be given more weight than other sources of media activation history. With regard to the example above, a user may provide social media input indicating that he likes the song Paradise by Coldplay. This source of media activation history source, that is social media input, may not be sufficient alone to determine that the user has previously activated the song Paradise by Coldplay. As a result, the song may not be included in the list of previously activated media items. However, if the song Paradise by Coldplay is present in a user's media preview history, this information in addition to the user's social media input related to the song may be sufficient to determine that the user has previously activated the song. Accordingly, the song Paradise would not be a discovery media item since the song would be included in the list of previously activated media items. Alternatively or in addition, various techniques may be used to identify previously activated media items from various sources of media activation history discovery media items to include in the list of previously activated media items.

Identifying a discovery media item may be performed according to various techniques. According to an implementation, identifying a discovery media item may include determining that the discovery media item has at least one attribute in common with at least one of the previously activated media items. For example, the list of previously activated media items may include the song Paradise. The song Paradise may have attributes such as artist—Coldplay, genre—rock, mood—chill, release date—2009, and the like. The list of previously activated media items may also include the song Diamonds, which may not be in the user's music library, but may be a song that was previously listened to by the user under a music subscription service. The song Diamonds may have attributes such as artist—Rihanna, genre—pop, mood—party, release date—2012. Next, discovery media items may be identified based on the songs Paradise and Diamonds in the list of previously activated media items. For example, a discovery song 1 may be a song that has been identified as being similar to Coldplay. A discovery song 2 may be a song from the genre rock and released in 2009. Similarly, a discovery song 3 may be a song that is by Rihanna. Additionally, a discovery song 4 may be a song from the genre—pop and categorized in the mood—party. The discovery songs, such as discovery songs 1-4, may not be in the list of previously activated media items.

According to an implementation, identifying a discovery media item may include determining at least one attribute shared by a plurality of previously activated media items, and selecting the discovery media item from a plurality of media items based upon the discovery media item having the at least one attribute. For example, the list of previously activated media items may include the songs shown in Table 1.

TABLE 1
User Media Activation History

| No. | Song | Album | Artist | Genre |
|---|---|---|---|---|
| 1 | Charlie Brown | Mylo Xyloto | Coldplay | Rock |
| 2 | Open Your Heart | True Blue | Madonna | Pop |
| 3 | Paradise | Mylo Xyloto | Coldplay | Rock |
| 4 | Locked Out of Heaven | Unorthodox | Bruno Mars | Pop |
| | | Jukebox | | |
| 5 | Diamonds | Unapologetic | Rihanna | Pop |
| 6 | Without Me | The Eminem | Eminem | Hip Hop |
| | | Show | | |

A plurality of media items may include the songs shown below in Table 2.

TABLE 2
Media Items

| No. | Song | Artist | Album | Genre |
|---|---|---|---|---|
| 1 | Mirrors | Justin | The 20/20 | Pop |
| | | Timberlake | Experience | |
| 2 | Diamonds | Rihanna | Unapologetic | Pop |
| 3 | Princess of | Coldplay | Mylo Xyloto | Rock |
| | China | | | |
| 4 | Holy Grail | Jay-Z | Magna Carta | Hip Hop |
| 5 | Midnight | AP | Pay the Man | Jazz |
| | Blues | | | |
| 6 | Umbrella | Rihanna | Good Girl | Pop |
| | | | Gone Bad | |

Based on the previously activated media items in Table 1, at least one attribute shared by a plurality of the previously activated media items may be determined. For example, attributes shared by a plurality of the previously activated media items in Table 1 include: album—Mylo Xyloto (songs #1 and #3), artist—Coldplay (songs #1 and #3), genre—rock (songs #1 and #3), and genre—pop (songs #2, #4, and #5). Next, one or more discovery media items may be selected based on the discovery media item having at least one attribute in common with the attributes determined based on the previously activated media items. Specifically, discovery songs may be selected based on the discovery song having one or more attributes including: album—Mylo Xyloto, artist—Coldplay, genre—rock, and genre—pop. From among the media items shown in Table 2 above, song #1 may be selected because it is from the genre—pop, song #3 may be selected because it is by the artist—Coldplay, from the album—Mylo Xyloto, and from the genre—rock, and song #6 may be selected because it is from the genre pop. Song #2 may not be selected as a discovery song because it is in the list of previously activated media items shown in Table 1. Song #4 may not be selected because the none of the attributes of song #4: artist—Jay-Z, album—Magna Carta, and genre—hip hop, were determined to be an attribute shared by a plurality of previously activated media items. Song #5 may not be selected as a discovery song because it does not have any attributes in common with the list of previously activated media items shown in Table 1.

In some instances, identifying the discovery media item may include generating a list of a plurality of discovery media items and selecting at least one discovery media item from the list based on the at least one discovery media item having at least one attribute in common with at least one of the previously activated media items. In connection with the example discussed above, a list of a plurality of discovery media items may be generated as shown in Table 2 above. From among the list of discovery media items, song #4 may be selected as a discovery song because it has the attribute genre—hip hop in common with the previously activated media item song #6 in Table 1. In some instances, a list of a plurality of discovery media items may be generated and each of the discovery media items in the list may not be in the list of previously activated media items. That is, all of the discovery media items in the list of discovery media items may be media items that a user has never activated before. In this case, one or more discovery media items may be selected from the list of discover media items based on the discovery media item having an attribute in common with the list of previously activated media items and/or based on a user media preference.

In an implementation, identifying the discovery media item may be based on user media preferences. In some instances, a user provided media preference may be an indication of an explicit selection of an attribute identified by a user. For example, a user may explicitly indicate that he likes funkadelic music; as a result, a discovery media item having any funkadelic relevant attributes may be identified, such as songs with one or more attributes such as: genre—funkadelic, artist—George Clinton, album—90's Funkadelic Hits, and the like. Additionally, user media preferences may be based on a variety of factors such as a user's media library, a user's media viewing history, a user's media listen history from media provider services, a user's media purchase history, a user's media preview history, a user's social media input, and any other similar data indicating a user's preference relating to media. For example, a user's media purchase history may indicate that she likes the artist Miley Cyrus. As a result, discovery media items having an attribute in common with the artist Miley Cyrus may be identified such as Hannah Montana songs. In general, similarities between any combination of previously activated media items, user media preferences, and discovery media items may be inferred and/or determined based on any comparison and combination of one or more attribute types.

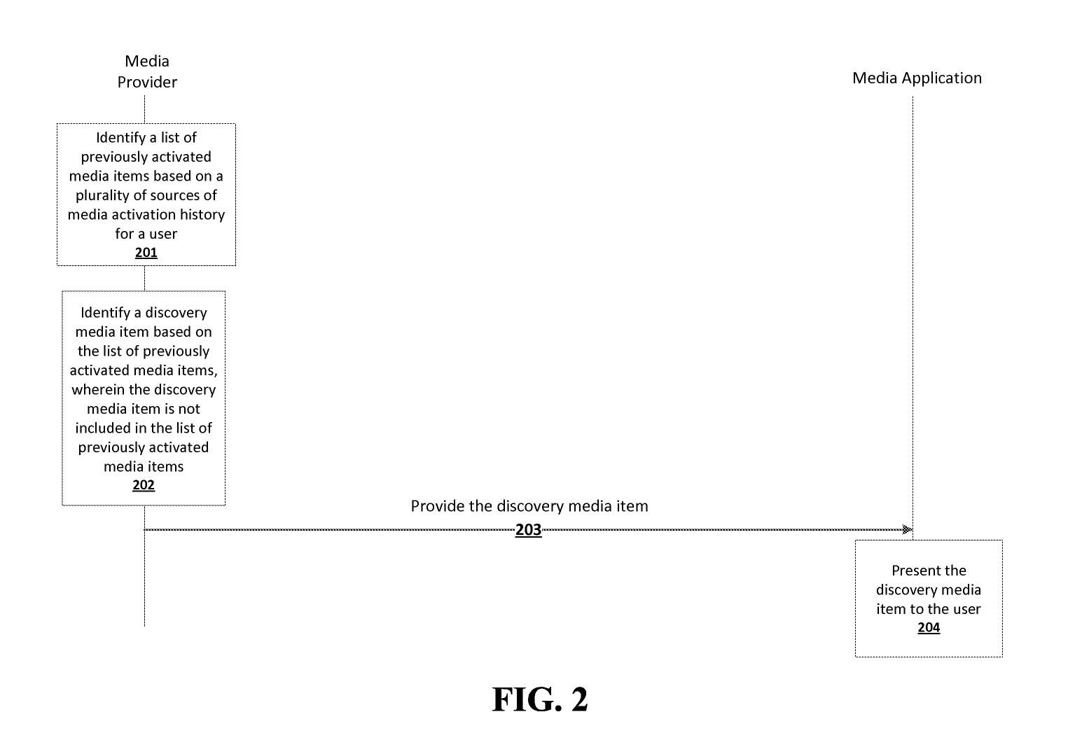

An implementation of the disclosed subject matter provides a system for identifying a discovery media item. FIG. 2 shows an example information flow according to an implementation. A system may include a processor configured to identify a list of previously activated media items based on a plurality of sources of media activation history for a user. As shown at 201, a media provider may identify a list of previously activated media items based on a plurality of sources of media activation history for a user. Each previously activated media item may have a plurality of attributes. Next, at 202, the media provider may identify a discovery media item based on the list of previously activated media items and the discovery media item may not be included in the list of previously activated media items. In an implementation, the discovery media item may be provided to the user and in some instances, providing the discovery media item to the user may be performed automatically, for example, the discovery media item may be automatically added to a user's media library. In addition or alternatively, a media provider may provide the discovery media item to a media application, at 203. Next, an indication of the discovery media item may be provided to the user, at 204. For example, a media application may present the discovery media item to the user, at 204. As another example, the discovery media item may be presented to the user in the form of a recommendation and/or suggestion for the user to purchase, preview, and/or play the discovery media item. As yet another example, the discovery media item may be added to an existing playlist of media items being accessed by the user.

As another example, a user's media library may include the movies Fight Club, Mrs. Doubtfire, and Inception. A user's movie preview history may indicate that the user recently watched a trailer for the movie Monsters, Inc. The user may have provided input to a social media network indicating that she “likes” the movie Apollo 13. Additionally, the user may have indicated that she prefers horror movies. In this case, the plurality of sources of media activation history for the user include the user's media library, the user's movie preview history, and the user's input to a social media network associated with a media item. A media provider may identify a list of previously activated media items and the list may include the movies Fight Club, Mrs. Doubtfire, Inception, Monsters, Inc., and Apollo 13. Each of the movies in the list may have multiple attributes such as those shown in Table 3 below.

TABLE 3
User Media Activation History

| | | | Release | | |
|---|---|---|---|---|---|
| No. | Movie | Genre | Date | Director | Actor(s) |
| 1 | Fight | Drama | 1999 | David | Brad Pitt, |
| | Club | | | Fincher | Edward Norton, |
| | | | | | Helena Bonham |
| | | | | | Carter |
| 2 | Mrs. | Drama | 1993 | Chris | Robin Williams, |
| | Doubtfire | | | Columbus | Sally Field, |
| | | | | | Pierce Brosnan |
| 3 | Inception | Action | 2010 | Christopher | Leonardo |
| | | Adventure | | Nolan | DiCaprio, |
| | | Mystery | | | Joseph Gordon- |
| | | | | | Levitt, Ellen |
| | | | | | Page |
| 4 | Monsters, | Animation | 2001 | Pete Docter | Billy Crystal, |
| | Inc. | Adventure | | | John Goodman, |
| | | Comedy | | | Mary Gibbs |
| 5 | Apollo 13 | Adventure | 1995 | Ron | Tom Hanks, |
| | | Drama | | Howard | Bill Paxton, |
| | | History | | | Kevin Bacon |

Based on the list of previously activated media items in Table 3 above, a media provider may identify a plurality of discovery media items. In this case, none of the movies Fight Club, Mrs. Doubtfire, Inception, Monsters, Inc., and Apollo 13 will be identified as a discovery media item since each was included in the list of previously activated media items. Instead, the list of discovery media items may include movies that the user has never activated before and which the user is likely to enjoy. A list of discovery media items may include movies that have an attribute in common with the attributes of the movies in the list of previously activated media items. For example, a discovery media item may be the movie Troy which has a common attribute, actor—Brad Pitt, with the previously activated movie Fight Club. Although the list of previously activated media items does not include any movies from the genre—horror, a discovery media item may be the horror movie Sleepy Hollow based on the user's indication that she prefers horror movies. The list of discovery media items may include the movies Momento, The Dark Knight, and The Prestige, all of which are directed by Christopher Nolan, the same director of the previously activated movie Inception. The list of discovery media items may also include movies with a release date in the mid 90's and of the genre—drama, based on the previously activated movies Mrs. Doubtfire and Apollo 13. Additionally, the list of discovery media items may include animation movies based on the previously activated movie Monsters, Inc. By identifying a comprehensive list of media items that have been previously activated by a user, the list of discovery media items provides a user with media items that are new to the user and which the user is likely to enjoy.

In an implementation, the communication between a media provider and a media application may be across one or more bridges between the interfaces. For example, the communications between the media provider and the media application may be managed or assisted by a third device, such as, a coordinating device, a local coordinator, a remote server, etc. In such cases, the third device may, for example, identifying a list of previously activated media items based on a plurality of sources of media activation history for a user. The third device may then provide the list of previously activated media items for a user to the media provider, in which case, the media provider may identifying a discovery media item based on the list of previously activated media items, wherein the discovery media item is not included in the list of previously activated media items. Alternatively, the third device may receive, from a media application, a list of previously activated media items based on a plurality of sources of media activation history for a user, and provide the list to the media provider. The media provider may identify a discovery media item based on the list of previously activated media items received. Accordingly, the media provider may provide a list of discovery media items to the user. Furthermore, more than one intermediate device may be implemented to facilitate communication between a media application and a media provider.

In situations in which the implementations of the disclosed subject matter collect personal information about users, or may make use of personal information, the users may be provided with an opportunity to control whether programs or features collect user information (e.g., a user's media viewing history, a user's media listen history from a media service provider, a user's media purchase history, a user's media preview history, a user's social media input associated with a media item, and any other similar data indicating a user's media activation history), or to control whether and/or how to receive media items from the media provider that may be more relevant to the user. In addition, certain data may be treated in one or more ways before it is stored or used, so that personally identifiable information is removed. For example, a user's identity may be treated so that no personally identifiable information can be determined for the user, or a user's geographic location associated with a social network may be generalized where location information is obtained (such as to a city, ZIP code, or state level), so that a particular location of a user cannot be determined. Thus, the user may have control over how information is collected about the user and used by a media provider.

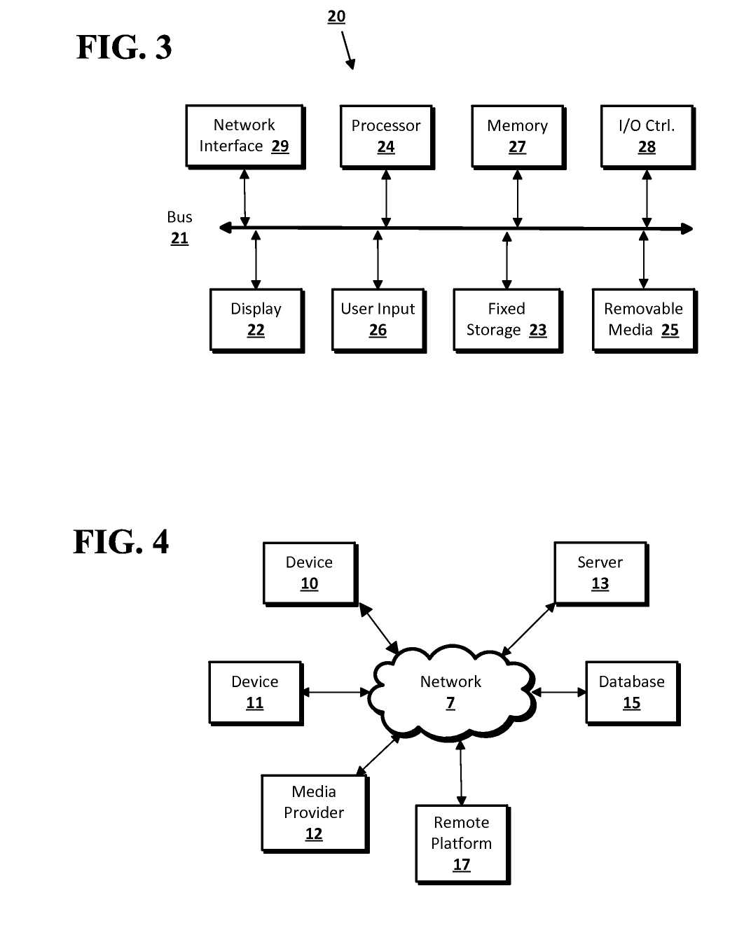

Embodiments of the presently disclosed subject matter may be implemented in and used with a variety of component and network architectures. FIG. 3 is an example computer 20 suitable for implementing embodiments of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 4.

Many other devices or components (not shown) may be connected in a similar manner (e.g., document scanners, digital cameras and so on). Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, removable media 25, or on a remote storage location.

FIG. 4 shows an example network arrangement according to an embodiment of the disclosed subject matter. One or more clients 10, 11, such as local computers, smart phones, tablet computing devices, media provider 12, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13, media provider 12, and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13, media provider 12, and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method comprising:
identifying, by a processor, a list of previously activated media items based on a plurality of sources of media activation history for a user, each previously activated media item having a plurality of attributes, and wherein at least one of the plurality of sources of media activation history for the user is a social media input of the user associated with a previously activated media item; and
identifying, by a processor, a discovery media item based on the list of previously activated media items, wherein the discovery media item is not included in the list of previously activated media items, and wherein identifying the discovery media item comprises:
generating a list of a plurality of discovery media items based on a first set of one or more attributes in common with at least one of the previously activated media items; and
selecting at least one discovery media item from the list based on the at least one discovery media item having a second set of at least one or more attributes that are different then the first set of one or more attributes in common with at least one of the previously activated media items.

2. The computer-implemented method of claim 1, further comprising providing an indication of the discovery media item to the user.

3. The computer-implemented method of claim 1, further comprising providing the discovery media item to the user.

4. The computer-implemented method of claim 3, wherein providing the discovery media item to the user is performed automatically.

5. The computer-implemented method of claim 4, further comprising adding the discovery media item to an existing playlist of media items being accessed by the user.

6-8. (canceled)

9. The computer-implemented method of claim 1, wherein each of the plurality of discovery media items is licensed by the user.

10. The computer-implemented method of claim 1, wherein the discovery media item is not licensed by the user.

11. The computer-implemented method of claim 1, wherein identifying the discovery media item is further based on user media preferences.

12. The computer-implemented method of claim 11, wherein the user media preferences comprise an indication of an explicit selection of at least one attribute identified by a user.

13. The computer-implemented method of claim 11, wherein the user media preferences are based on at least one selected from the group consisting of:
user provided media preferences, a media library of the user, a media viewing history of the user, a media listen history of the user from media provider services, a media purchase history of the user, a media preview history of the user, a social media input of the user, and any other similar data indicating a preferences of a user relating to media.

14. The computer-implemented method of claim 1, wherein the plurality of sources of media activation history for a user are selected from the group consisting of:
a media library of the user, a media viewing history of the user, a media listen history of the user from a media service provider, a media purchase history of the user, a media preview history of the user, a review/rating history of the user associated with a media item, and any other similar data indicating a media activation history for a user.

15. The computer-implemented method of claim 1, wherein each of the plurality of attributes is an attribute selected from the group consisting of:
artist, album, genre, mood, tempo, release date, producer, actor, author, and other properties relating to a previously activated media item.

16. A system comprising:
a processor configured to:
identify a list of previously activated media items based on a plurality of sources of media activation history for a user, each previously activated media item having a plurality of attributes, and wherein at least one of the plurality of sources of media activation history for the user is a social media input of the user associated with a previously activated media item; and
identify a discovery media item based on the list of previously activated media items, wherein the discovery media item is not included in the list of previously activated media items, and wherein, the processor is configured to:
identify the discovery media item by generating a list of a plurality of discovery media items based on a first set of one or more attributes in common with at least one of the previously activated media items; and
select at least one discovery media item from the list based on the at least one discovery media item having a second set of at least one or more attributes that are different then the first set of one or more attributes in common with at least one of the previously activated media items.

17. The system of claim 16, wherein the processor is further configured to provide an indication of the discovery media item to the user.

18. The system of claim 16, wherein the processor is further configured to provide the discovery media item to the user.

19. The system of claim 17, wherein providing the discovery media item to the user is performed automatically.

20. The system of claim 19, wherein the processor is further configured to add the discovery media item to an existing playlist of media items being accessed by the user.

21-23. (canceled)

24. The system of claim 16, wherein each of the plurality of discovery media items is licensed by the user.

25. The system of claim 16, wherein the discovery media item is not licensed by the user.

26. The system of claim 16, wherein identifying the discovery media item is further based on user media preferences.

27. The system of claim 26, wherein the user media preferences comprise an indication of an explicit selection of at least one attribute identified by a user.

28. The system of claim 26, wherein the user media preferences are based on at least one selected from the group consisting of:
user provided media preferences, a media library of the user, a media viewing history of the user, a media listen history of the user from media provider services, a media purchase history of the user, a media preview history of the user, a social media input of the user, and any other similar data indicating a preferences of a user relating to media.

29. The system of claim 16, wherein the plurality of sources of media activation history for a user are selected from the group consisting of:
a media library of the user, a media viewing history of the user, a media listen history of the user from a media service provider, a media purchase history of the user, a media preview history of the user, a review/rating history of the user associated with a media item, and any other similar data indicating a media activation history for a user.

30. The system of claim 16, wherein each of the plurality of attributes is an attribute selected from the group consisting of: artist, album, genre, mood, tempo, release date, producer, actor, author, and other properties relating to a previously activated media item.
